(19) United States
(12) Patent Application Publication
(10) Pub. No.: US 2025/0069007 A1
(43) Pub. Date: Feb. 27, 2025

(54) DATA COLLECTION DISPLAY SYSTEM AND DATA COLLECTION DISPLAY METHOD

(71) Applicant: Hitachi, Ltd., Tokyo (JP)

(72) Inventors: Hitoshi ISHIDA, Tokyo (JP); Takehiro HAGIWARA, Tokyo (JP); Riku KAWAMURA, Tokyo (JP)

(21) Appl. No.: 18/589,049

(22) Filed: Feb. 27, 2024

(30) Foreign Application Priority Data
Aug. 24, 2023 (JP) 2023-136189

(51) Int. Cl. G06Q 10/0631

(52) U.S. Cl. CPC G06Q 10/06316

(57) ABSTRACT

Proposed are a data collection display system and a data collection display method capable of reducing the time required for identifying on-site data even when a product is defective. A data collection display system comprises an on-site data accumulation unit, a association data accumulation unit, a model history as an example of a version management unit, a model creation unit as an example of a version identifier update unit, an association data registration unit, a model search unit, and a provision data generation unit.

### CROSS-REFERENCE TO RELATED APPLICATION

The present application claims priority from Japanese application JP2023-136189, filed on Aug. 24, 2023, the contents of which is hereby incorporated by reference into this application.

### TECHNICAL FIELD

The present invention relates to a data collection display system and a data collection display method and, for example, can be suitably applied to a data collection display system that collects on-site data from on-site data generation devices arranged in the factory's production equipment.

### BACKGROUND ART

In recent years, a method of arranging numerous data collection equipment on the production line of the factory's production equipment, and collecting on-site data in real-time using such numerous data collection equipment, is being performed. The thus collected on-site data is accumulated as a data lake on a platform.

In order to investigate the cause of a defective product produced on a production line, it is necessary to analyze, based on relevant on-site data, what kind of task process was used to manufacture the defective product and how each of the tasks configuring that task process was conducted. Nevertheless, since the task process changes over time, the task model for managing the task process must be updated together with the change in the task process, and the version thereof needs to be managed. As a method of managing the version of task models, there is the method described in PTL 1. PTL 1 adopts a management method of linking the task model version and the on-site data based on the operation start and end date/time of the task model. If a product is defective, the on-site data of the defective product is acquired and utilized for investigating the cause of the defect based on the operation start and end date/time of the task model for each task model version.

### CITATION LIST

### Patent Literature

[PTL 1] Japanese Patent Application No. 2005-111198

### SUMMARY OF THE INVENTION

### Problems to be Solved by the Invention

Nevertheless, with the method disclosed in PTL 1, it is necessary to designate the operation start and end date/time of the task model for each task model version and search the previous task model corresponding to the defective product, and identify the on-site data corresponding to the previous task model. Such being the case, it takes much time to identify the on-site data related to the defective product.

The present invention was devised in view of the foregoing points, and an object of this invention is to propose a data collection display system and a data collection display method capable of reducing the time required for identifying the on-site data even when a product is defective.

### Means to Solve the Problems

In order to achieve the foregoing object, the present invention provides a data collection display system, comprising: an on-site data accumulation unit which accumulates on-site data; a association data accumulation unit which accumulates a plurality of association data, which is data for managing relevance between tasks and which associates a task node corresponding to the task and the on-site data related to the task; a version management unit which manages a version identifier of a plurality of process models by associating it with model information of the plurality of process models; a version identifier update unit which, each time any process model among the plurality of process models is updated, updates the version identifier managed by the version management unit by associating it with the model information of the updated process model; a association data registration unit which registers association data based on a process model corresponding to a specific version identifier among the plurality of process models; a model information search unit which searches the version management unit with the date/time or version identifier corresponding to the updated process model as a search key, and searches for model information that coincides with the search key among the plurality of process models; and a provision data generation unit which identifies the task and the on-site data related to the task from the relevant data related to the process model corresponding to the model information, and externally provides the identified data.

The present invention additionally provides a data collection display method of a data collection display system which collects on-site data, the method comprising: an on-site data accumulation step of accumulating the on-site data in an on-site data accumulation unit; a association data accumulation step of accumulating a plurality of association data, which is data for managing relevance between tasks and which associates a task node corresponding to the task and the on-site data related to the task, in a association data accumulation unit; a version management step of using a version management unit and managing a version identifier of a plurality of process models by associating it with model information of the plurality of process models; a version identifier update step of a version identifier update unit, each time any process model among the plurality of process models is updated, updating the version identifier managed by the version management unit by associating it with the model information of the updated process model; a association data registration step of registering association data based on model information of a process model corresponding to a specific version identifier among the plurality of process models;

a model information search step of a model search unit searching the version management unit with the date/time or version identifier corresponding to the updated process model as a search key, and searching for model information that coincides with the search key among the plurality of process models; and a provision data generation step of a provision data generation unit identifying the task and on-site data related to the task from the relevant data related to the process model corresponding to the model information, and externally providing the identified on-site data.

According to the present invention, in a case of investigating the cause of a defective product while comparing the on-site data of the defective product and the on-site data of products before and after such defective product, even if the process model when the on-site data related to the defective product was created is different from the process model when the on-site data related to the products before and after such defective product was created, since it is possible to also search for the on-site data related to the products before and after the defective product based on the process model when the on-site data related to the defective product was created, it is possible to reduce the time required for investigating the cause of the defective product even when a product becomes defective under circumstances where the process model is updated sequentially.

### Advantageous Effects of the Invention

According to the present invention, it is possible to realize a data collection display system and a data collection display method capable of reducing the time required for identifying the on-site data even when a product is defective.

### BRIEF DESCRIPTION OF DRAWINGS

FIG. 1 is a block diagram showing a system configuration example of the data collection display system according to the present embodiment.

FIG. 2 is a block diagram showing an example of the functions of the information collection display system according to the present embodiment.

FIG. 3 is a diagram explaining an example of the data structure of the process model.

FIG. 4A is a schematic diagram showing an update example of the process model.

FIG. 4B is a schematic diagram showing an update example of the process model.

FIG. 4C is a schematic diagram showing an update example of the process model.

FIG. 4D is a schematic diagram showing an update example of the process model.

FIG. 5 is a diagram explaining an example of the data structure of the association data.

FIG. 6 is a diagram showing an example of the update sequence of the process model.

FIG. 7 is a diagram showing an example of the version destination process model search sequence.

FIG. 8 is a diagram showing an example of the registration sequence of the association data.

FIG. 9 is a diagram showing an example of the search sequence of the association data and the on-site data.

FIG. 10 is a diagram showing an example of the search screen of the process model and the on-site data.

FIG. 11 is a diagram showing an example of the search screen of the process model and the on-site data.

FIG. 12A is a diagram showing an example of the model history table configuring the model history.

FIG. 12B is a diagram showing an example of the model history table configuring the model history.

FIG. 12C is a diagram showing an example of the model history table configuring the model history.

FIG. 13A is a diagram showing an example of the model history table.

FIG. 13B is a diagram showing an example of the model history table.

FIG. 13C is a diagram showing an example of the model history table.

FIG. 13D is a diagram showing an example of the model history table.

FIG. 14 is a diagram showing an example of the search sequence of the association data and the on-site data according to a modified example of the present embodiment.

FIG. 15 is a diagram showing the search image of the association data.

### DESCRIPTION OF EMBODIMENTS

An embodiment of the present invention is now explained in detail with reference to the appended drawings.

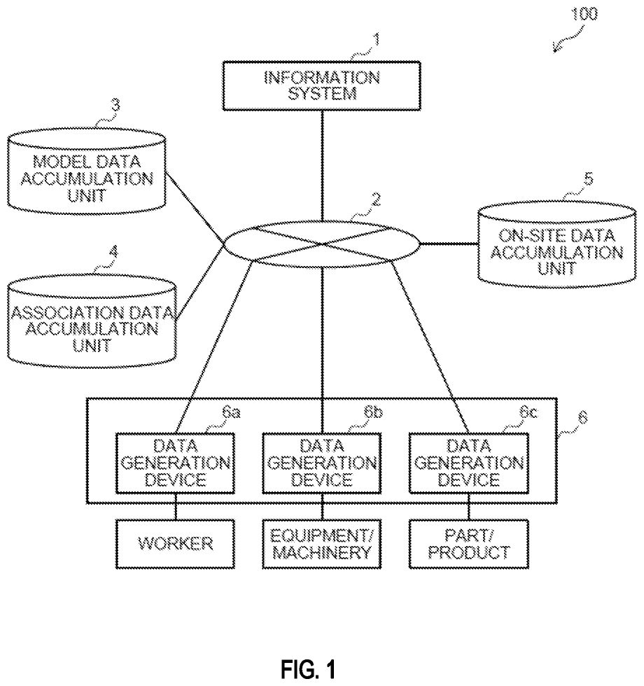

FIG. 1 is a block diagram showing a system configuration example of a data collection display system 100 according to the present embodiment. The data collection display system 100 comprises data generation devices 6a, 6b, 6c, a model data accumulation unit 3, a association data accumulation unit 4, an on-site data accumulation unit 5 and a network 2. The data generation devices 6a, 6b, 6c, the model data accumulation unit 3, the association data accumulation unit 4 and the on-site data accumulation unit 5 are mutually connected via the network 2. When there is no need to specifically differentiate the data generation devices 6a, 6b, 6c, they will be simply indicated as “data generation device(s) 6”.

The data generation device 6 is, for example, a barcode reader for acquiring the work logs of a worker or a PC or a server for collecting work logs (for example, data generation device 6a), a sensor for collecting inspection information of an RFID (Radio Frequency IDentifier) appended to a part or a product (finished product) (for example, data generation device 6c), or a machine which performs the processing of parts or the assembly of finished products (for example, data generation device 6c). On-site data as the real data collected or generated with these data generation devices 6 is sent to an information system 1, the model data accumulation unit 3, or the on-site data accumulation unit 5 via the network 2.

The model data accumulation unit 3 is, for example, a storage device such as a server or a memory, and accumulates process models (hereinafter sometimes simply referred to as “models”) which define what kind of information should be accumulated in the on-site data accumulation unit 5. This model is also referred to as master data. A process model is updated with time, and is managed based on its version. By changing the model defined with the model data accumulation unit 3, the setting of what kind of on-site data (type of information to be collected) should be collected from the data generation devices 6a, 6b, 6c can be changed. The models of the model data accumulation unit 3 can be set or changed via an external device (not shown).

The on-site data accumulation unit 5 is, for example, a storage device such as a server or a memory, and accumulates on-site data including information defined with the models of the model data accumulation unit 3. In the present embodiment, on-site data is accumulated in the on-site data accumulation unit 5. On-site data is, for example, data such as the type identification information, date/time of occurrence and measured value of on-site data acquired by the data generation device 6.

The key functions of the information system 1 are now explained. The data collection display system 100 includes a CPU (Central Processing Unit) which performs the overall control of the information system 1, a storage device (Read Only Memory: ROM) which stores various control programs for performing the control of the information system 1, a primary storage device (Random Access Memory: RAM) which temporarily stores information processed by the CPU, and an HDD (Hard Disk Drive), and the following functions are realized by the CPU executing the respective control programs stored in the ROM.

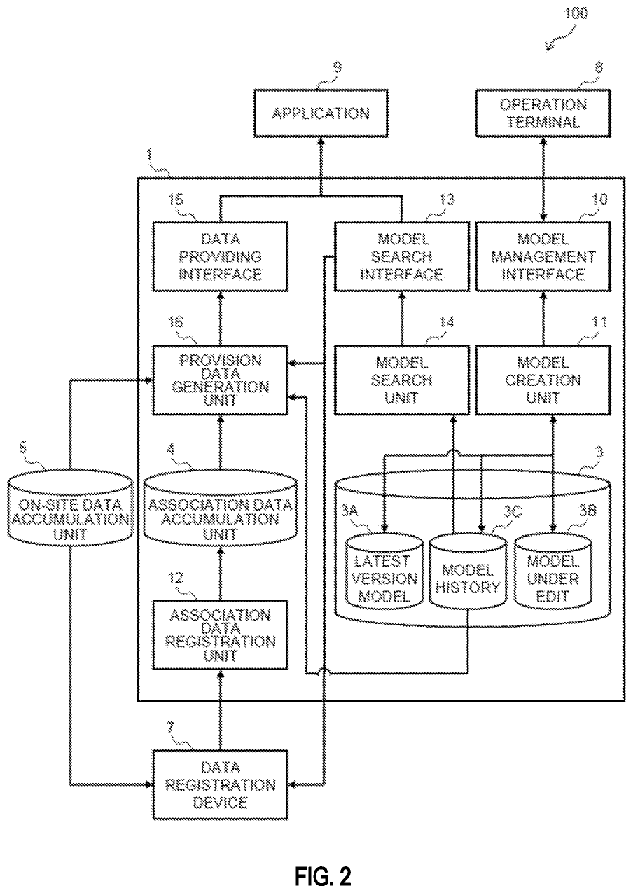

FIG. 2 is a block diagram showing an example of the functions of the data collection display system 100 according to the present embodiment. The data collection display system 100 comprises a data registration device 7, a association data registration unit 12, a association data accumulation unit 4, a provision data generation unit 16, a data providing interface 15, a model data accumulation unit 3, a model creation unit 11, a model management interface 10, a model search unit 14 and a model search interface 13. The data registration device 7 and the provision data generation unit 16 acquire on-site data from the on-site data accumulation unit 5.

The model data accumulation unit 3 includes a latest version model 3A, a model under edit 3B and a model history 3C. The model under edit 3B manages a process model in which its update has been started and which is being updated among a plurality of process models. The latest version model 3A manages a latest version process model of the model under edit in which its update has been completed. The model history 3C is an example of the version management unit, and manages at least a version identifier of a plurality of process models by associating it with model information of a plurality of process models. Nevertheless, the latest version model 3A shall be the latest model of the model history 3C, and the latest version model 3A and the model history 3C do not need to be managed separately.

The model creation unit 11 has a function of creating the latest version model 3A, the model under edit 3B and the model history 3C. When the update of the process model to be updated (hereinafter referred to as the “update target process model”) among a plurality of process models is started, the model creation unit 11 causes the update target process model to be the model under edit 3B, and registers in the model history 3C that the update target process model is being updated. Moreover, when the update of the update target process model is completed, the model creation unit 11 causes the update target process model to be the latest version model 3A, and registers in the model history 3C that the update of the update target process model has been completed. A version identifier indicating the version of the updated process model is registered in the model history 3C together with the model information of the update target process model.

The model management interface 10 is a user interface such as a display, and has a function of displaying the latest version model 3A, the model under edit 3B and the model history 3C created by the model creation unit 11 on the user's operation terminal 8. Moreover, the model management interface 10 is configured so that the user can input prescribed information and operations into the model creation unit 11. Otherwise, the model management interface 10 may also be an API (Application Programming Interface) which sends and receives information based on a prescribed data structure.

The model history 3C described above is an example of the version management unit, and manages a version identifier which shows each version history of a plurality of process models. The model creation unit 11 is an example of the version identifier update unit, and, each time any process model among a plurality of process models is updated, updates the version identifier of the process model managed by the model history 3C by associating it with the model information of the updated process model.

The model search unit 14 has a function of searching for information related to the latest version model 3A, the model under edit 3B and the model history 3C. The model search interface 13 is a user interface such as a display, and has a function of presenting, to an application 9, information related to the latest version model 3A, the model under edit 3B and the model history 3C searched by the model search unit 14. Otherwise, the model search interface 13 may also be an API (Application Programming Interface) which sends and receives information based on a prescribed data structure.

The model search unit 14 is an example of the model information search unit, and has a function of extracting a specific process model which may be related to the version identifier corresponding to the updated process model with the version identifier corresponding to the updated process model or the date/time (search date/time) as the search key according to the search conditions of the updated process model.

The data registration device 7 acquires on-site data from the on-site data accumulation unit 5 in the manner described above, and delivers the acquired on-site data to the association data registration unit 12.

The association data registration unit 12 has a function of acquiring on-site data from the data registration device 7, and acquiring the models (latest version model 3A, model under edit 3B and model history 3C) searched by the model search unit 14 via the model search interface 13.

The association data registration unit 12 is an example of the association data registration unit, and manages association data for managing the relevance between a plurality of on-site data, and registers association data based on a process model of a specific version acquired via the model search interface 13.

The association data registration unit 12 creates definition information based on the process model from the model data accumulation unit 3 in accordance with the model input from the model search interface 13. The definition information created by the association data registration unit 12 has a prescribed data structure, and the association data registration unit 12 defines based on what kind of data structure the on-site data should be acquired from the data generation device 6.

The association data registration unit 12 receives on-site data from the data generation device 6, and structures the on-site data based on the data structure defined by the definition information. The association data registration unit 12 determines whether the on-site data acquired according to the definition information is information related to task, worker, machine, work procedure or material (part) based on the identification information assigned to the on-site data. In the following explanation, the initial M of HuMan, Machine, Method, and Material is taken and these items are sometimes referred to as 4M information (or 4M node) or task related information.

Here, the association data registration unit 12 is defined with the relationship of the 4M information and the identification information assigned to the on-site data, and the association data registration unit 12 associates the 4M information determined by the association data registration unit 12 and the actually acquired on-site data based on this definition (maps the identification information of the on-site data with the 4M information). The association data registration unit 12 registers the 4M information, after it has been associated with the on-site data, in the association data accumulation unit 4. Furthermore, the association data registration unit 12 comprises a temporary accumulation unit, and the temporary accumulation unit registers information for configuring a connection relationship (generating a connecting line) of each piece of information (task information and 4M information) included in the on-site data.

The provision data generation unit 16 acquires on-site data from the on-site data accumulation unit 5 based on the association data 500 accumulated in the association data accumulation unit 4.

When the user selects the 4M information of a prescribed task from the model search interface 13, the association data registration unit 12 searches for other 4M information of the task related to the corresponding 4M information based on the identification information assigned to the corresponding 4M information, and presents the searched 4M information to the user by displaying it on the user interface via hatching or color coding. Moreover, the association data registration unit 12 registers, in the association data accumulation unit 4, the connection relationship of the selected 4M information and the searched 4M information.

The provision data generation unit 16 acquires on-site data from the on-site data accumulation unit 5 in the manner described above. The provision data generation unit 16 acquires association data from the association data accumulation unit 4. Association data is data for managing the relevance between tasks, and associates the task node and the on-site data corresponding to the task. The provision data generation unit 16 acquires the model history 3C from the model data accumulation unit 3. Specifically, the provision data generation unit 16 acquires information related to the version of the updated model from the model history 3C.

The provision data generation unit 16 is an example of the provision data generation unit, and acquires specific association data based on the process model extracted by the model search unit 14 via the model search interface 13. The provision data generation unit 16 identifies a plurality of specific on-site data being managed based on the specific association data, and provides the identified on-site data externally; that is, to the application 9, via the data providing interface 15. The user can comprehend the on-site data via the application 9. Here, the data providing interface 15 may be a GUI (Graphical User Interface) which provides an input/display screen to the user, or an API which sends and receives information based on a prescribed data structure.

The association data accumulation unit 4 accumulates the connection relationship of the selected task information and the 4M information sent from the association data registration unit 12. The provision data generation unit 16 can use task information or 4M information across a plurality of tasks in various analytical methods by sending, to the application 9, other 4M information of the task related to the selected task information or 4M information or the on-site data acquired based on task information or 4M information of other related tasks based on the connection relationship of the task information and the 4M information accumulated in the association data accumulation unit 4.

In the data collection display system 100, the provision data generation unit 16 sends, to the application 9, data associated by the association data 500 via the data providing interface 15. Here, the provision data generation unit 16 is connected to a dictionary database. Here, the item names, etc. of the 4M information being used in each manufacturing process (task) may differ depending on the manufacturing process. Thus, in the dictionary database (not shown), different terms having the same meaning as the item names of the 4M information used in each manufacturing process are associated and registered, and the provision data generation unit 16 can accurately acquire data, which has been associated by the association data 500, including different terms having the same meaning in addition to the same terms.

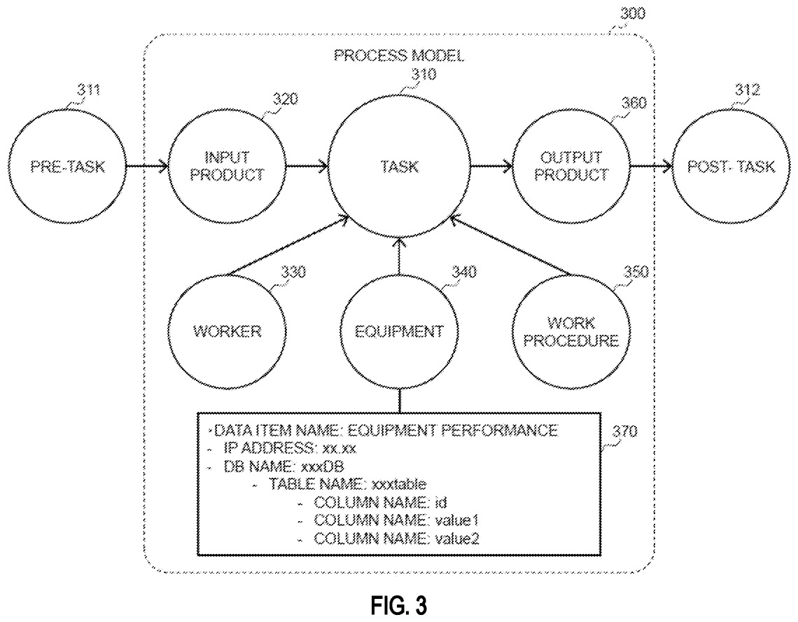

An example of the data structure of the process model 300 managed by the data collection display system 100 is now explained. FIG. 3 is a diagram explaining an example of the data structure of the process model 300. This process model 300 is data accumulated in the model data accumulation unit 3. The process model 300 is configured from tasks configuring the task processes of the manufacturing task, logistics task and other tasks and the constituent elements of 4M related to the tasks and their relationship, and management information of data items related to each task or 4M and on-site data corresponding to such data items.

The process model 300 can, based on its data structure, show what kind of worker, machine, part or the like is related to what kind of work procedure in what manner in a prescribed task (manufacturing process) by associating at least one on-site data generated from various devices (data generation devices 6) in each manufacturing process. In the present embodiment, the process model 300 includes, centered around a task node 310, an input product node 320 that indicates the materials required for executing the task, a worker (HuMan) node 330 that conducts the task, an equipment (Machine) node 340 that is used for implementing the task, a work procedure (Method) node 350 that defines the implementation procedure of the task, and an output product (Material) node 360 that is generated as a result of implementing the task with parts as the materials. The output product node 360 generated by implementing the task node 310 becomes the materials (parts) to be used in the post-process task node 312, and the input product node 320 to become the material of the task node 310 is the finished product generated in the pre-process task node 311. In other words, the input product node 320 and the output product node 360 are the same type in the sense that the attributes have the same meaning, and these may be collectively referred to as “material node(s)” if there is no need to specifically differentiate the two. Moreover, as described above, the input product node 320, the worker node 330, the equipment node 340, and the work procedure node 350 are referred to as 4M information or 4M nodes. The data items related to each task and 4M and the management information of the on-site data corresponding to such data items are configured, for example, from a data item name, an IP address of the corresponding on-site data accumulation unit, a database (DB) name, a table name and a column name as shown in the on-site data management information 370.

Association data 500 has a structure that is similar to that of the process model 300, and is configured from identification information of a task target and identification information of 4M information for each task target of each task, and their relationship. For example, if the task in the process model is an assembly task, the task target is the product to be assembled, and the identification information of the task target is the serial number or the lot number of the product. For example, of the 4M information, the identification information of the input product is the serial number or the lot number of the parts used in the assembly, and the identification information of the equipment is the identifier or the like for identifying the performance value upon assembling the product in the equipment used in the assembly work. In the data collection display system 100, if the product itself encounters a problem, it is possible to search for the 4M information associated with the finished product based on the association data 500, and find the cause of the problem in a prescribed manufacturing process (task). In the present embodiment, explained is a case where identification information is assigned to each on-site data that was collected or generated by the data generation device 6 in each manufacturing process. With the data collection display system 100, the relevance between tasks can be managed by accumulating the association data 500, which defines the relevance of machines and workers related to the task, across a plurality of manufacturing processes (tasks).

The basic information of this association data 500 is the identification information indicating each piece of information and the timing (date/time) related to the relevance with the identification information. The on-site data (real data) indicated by each piece of identification information of the association data 500 is accumulated in the on-site data accumulation unit 5 which is being managed externally, and the method of accessing the on-site data accumulated in the on-site data accumulation unit 5 is being managed in the data collection display system 100 based on the management information 370 of the on-site data in the process model 300.

The association data described above is configured from the task node 310 and 4M information. The connecting line which connects the respective nodes uses items required for executing the task as the input and the finished product generated based on the effect as the output, and these are expressed with a digraph.

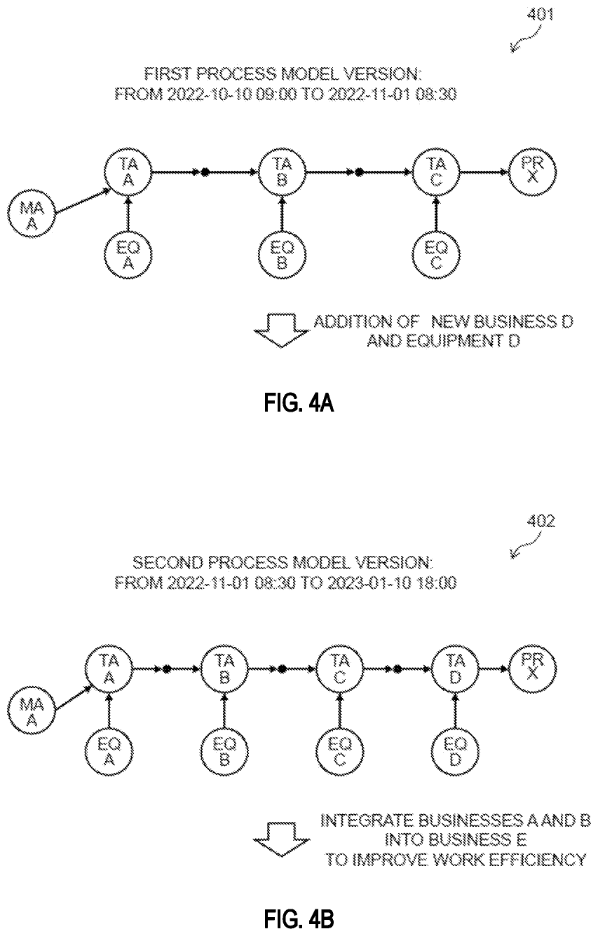

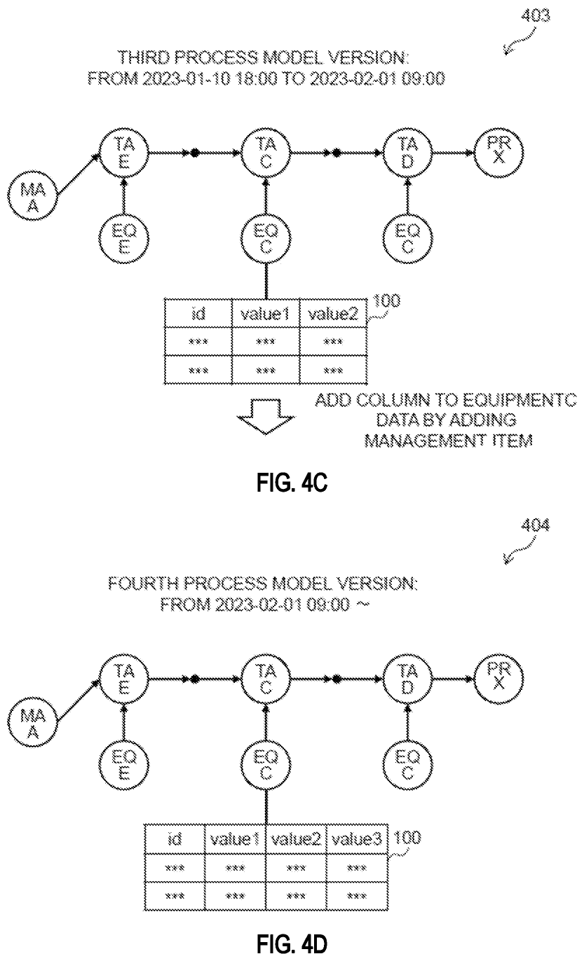

FIG. 4A to FIG. 4D are schematic diagrams showing an update example of the process model. A first process model version 401 shown in FIG. 4A indicates the process model version of the first process model from Oct. 10, 2022; 9:00 to Nov. 1, 2022; 08:30. When a new task D and new equipment (hereinafter partially shown as ‘EQ’ in the drawings) D are added between a task C and a product (hereinafter partially shown as ‘PR’ in the drawings) X in the process model shown in FIG. 4A, it becomes a second process model shown in FIG. 4B.

A second process model version 402 shown in FIG. 4B indicates the process model version of the second process model from Nov. 1, 2022; 08:30 to Jan. 10, 2023; 18:00. When a task (hereinafter partially shown as ‘BU’ in the drawings) A and a task B are integrated into a task E to improve work efficiency, it becomes a third process model shown in FIG. 4C.

A third process model version 403 shown in FIG. 4C indicates the process model version of the third process model from Jan. 10, 2023; 18:00 to Feb. 2, 2023; 9:00. When a column of “value 3” is added to the on-site data of the equipment C by adding a management item, it becomes a fourth process model shown in FIG. 4D. The fourth process model version 404 indicates the process model version of the fourth process model from Feb. 2, 2023; 9:00 onward.

In the present embodiment, the process model may be updated by the model creation unit 11 with time as described above, and the model creation unit 11 manages the version of the process model as the version identifier each time the process model is updated, and accumulates the version identifier in the model history 3C by associating it with the updated process model. Here, the process model may be updated, as shown in FIG. 4A to FIG. 4D, when there is any change (addition, deletion, change) to the constituent elements of the task or 4M, information of the data items of each task or 4M, management information of the on-site data corresponding to the data items, or information of the order of task or the relationship of the task and 4M.

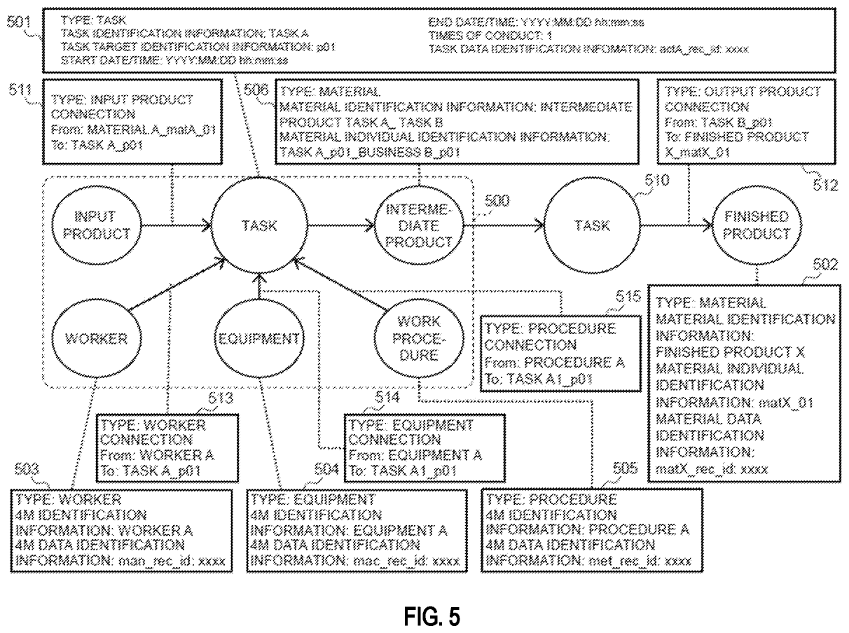

FIG. 5 is a diagram showing an example of the data structure of the association data. This illustrated example shows the association data corresponding to a plurality of tasks therebefore and thereafter.

The illustrated association data relates to a certain task and a post-process task which is downstream, and includes, centered around a task node 501, an input product node that indicates the materials required for executing the task, an edge 511, a worker node 503 that conducts the task, an edge 513, an equipment node 504 that is used for implementing the task, an edge 514, a work procedure node 505 that defines the implementation procedure of the task, an edge 515, and an intermediate product node 506 that is generated as a result of implementing the task with parts as the materials.

The task node 501 is positioned at the center of the corresponding task, and is used for acquiring the worker node 503, the equipment node 504, and the work procedure node 505 as examples of the on-site data respectively connected by the edge 513, the edge 514, and the edge 515.

Moreover, the intermediate product node 506 generated by implementing the task node 501 becomes the materials (parts) for use in the post-process task node 510, and the intermediate product node 506 to become the finished product of the task node 501 becomes the materials (parts) for use in the post-process task node 510.

The illustrated association data includes, with regard to the post-process task centered around a task node 510, an intermediate product node 506 as an input product node that indicates the materials required for executing the task, and an edge 512 of the finished product node 502 as the output product generated as a result of implementing the task with parts as the materials.

The overview of the information collection display method of the data collection display system 100 according to the present embodiment is now explained. As described above, the data collection display system 100 collects the on-site data generated by the data generation device 6. This information collection display method includes an on-site data accumulation step of accumulating the on-site data in the on-site data accumulation unit 5, a association data accumulation step of accumulating a plurality of association data, which is data for managing relevance between tasks and which associates a task node corresponding to the task and the on-site data related to the task, in the association data accumulation unit 4, a version management step of using the model history 3C as an example of the version management unit and managing a version identifier of a plurality of process models by associating it with model information of the plurality of process models, a version identifier update step of the model creation unit 11 as an example of the version identifier update unit, each time any process model among the plurality of process models is updated, updating the version identifier managed by the model history 3C as an example of the version management unit by associating it with the model information of the updated process model, a association data registration step of the association data registration unit 12 registering association data in the association data accumulation unit 4 based on model information of a process model corresponding to a specific version identifier among the plurality of process models, a model information search step of the model search unit 14 searching the model history 3C with the date/time or version identifier corresponding to the updated process model as a search key, and searching for model information that coincides with the search key among the plurality of process models, and a provision data generation step of the provision data generation unit 16 identifying the task and on-site data related to the task from the relevant data related to the process model corresponding to the model information, and externally providing the identified on-site data. Each step is now explained in detail.

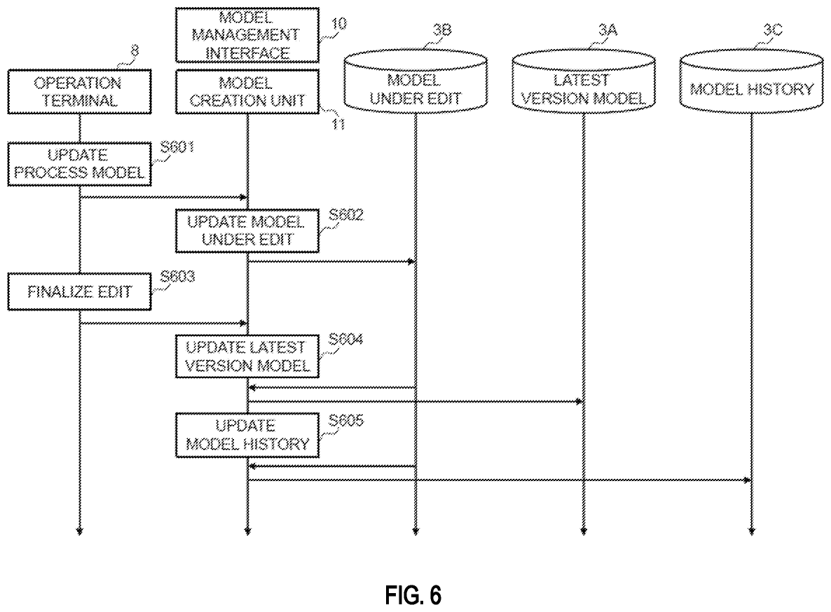

FIG. 6 is a diagram showing an example of the update sequence of the process model. Foremost, in step S601, when the operation terminal 8 makes a request for starting the update of the process model pursuant to a change in the manufacturing process, this update start request is received by the model creation unit 11 via the model management interface 10. Here, there may be a case where the association data from the data registration device 7 is registered even in an intermediate stage of the update work of the process model. Here, in order to avoid the registration of the association data based on the process model in an intermediate state, in step S602, the update work of the process model is performed to the model under edit 3B.

Next, in step S603, when the operation terminal 8 finalizes the editing of the process model, the editing finalization request is received by the model creation unit 11 via the model management interface 10. In step S604, the model creation unit 11 causes the model under edit 3B to become the latest version model 3A based on this editing finalization request.

Next, in step S605, the model creation unit 11 updates the model history 3C by adding the model under edit 3B to the model history 3C together with the version identifier of the process model.

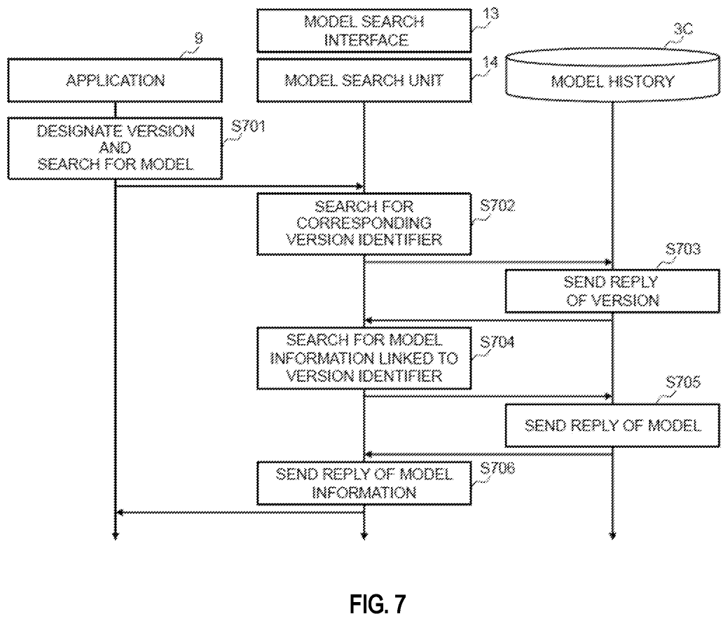

FIG. 7 is a diagram showing an example of the version designation process model search sequence. In the version destination process model search sequence, the model information of the process model is searched as the table of contents for searching the on-site data.

Foremost, in step S701, the application 9 makes a search request which designates the date/time or version identifier of the process model, for instance, in order to acquire the on-site data related to a defective product. The search request is received by the model search unit 14 via the model search interface 13.

Next, in step S702, the model search unit 14 makes a search request to the model history 3C based on the search request with the version identifier of the process model or the date/time as the search key. Then, in step S703, if there is a model history corresponding to the date/time or the foregoing version identifier of the process model in the model history 3C, the model search unit 14 receives the version identifier of the process model as its reply.

Next, in step S704, the model search unit 14 makes a search request of the model information linked to the version identifier of the process model. Note that step S704 may be integrated with step S702 by being executed concurrently with step S702. In step S705, when the model information linked to the version identifier of the process model exists in the model history 3C, the model search unit 14 receives the model information thereof as its reply.

Next, in step S706, the model search unit 14 sends a reply of the model information to the application 9 via the model search interface 13.

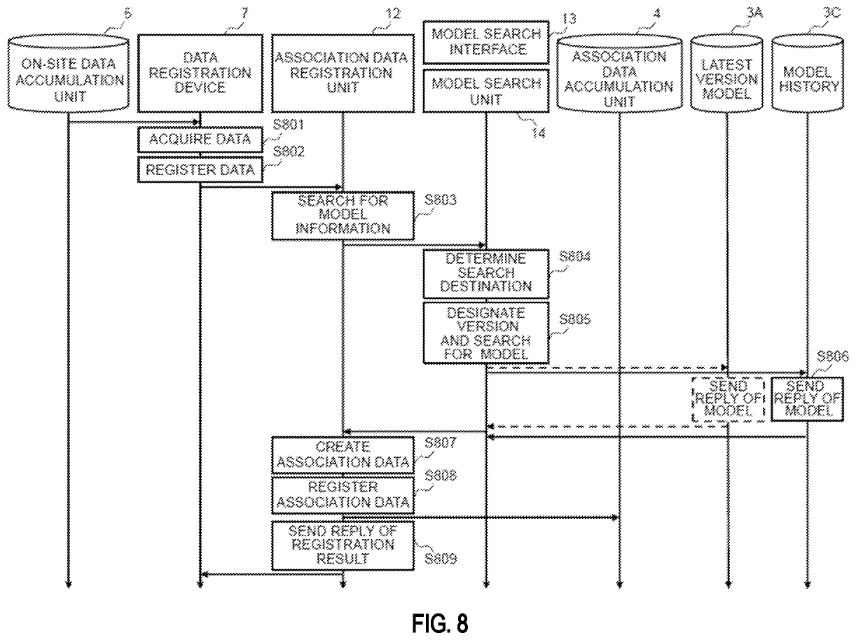

FIG. 8 is a diagram showing an example of the registration sequence of the association data. As described above, on-site data is sequentially accumulated in the on-site data accumulation unit 5. In step S801, the data registration device 7 acquires on-site data from the on-site data accumulation unit 5. In step S802, the data registration device 7 registers on-site data in the association data registration unit 12. Here, the data registration device 7 may register the on-site data by designating the version identifier of the process model, or register the on-site data without designating the version identifier of the process model.

In step S803, the association data registration unit 12 makes a search request of the model information to the model search unit 14 via the model search interface 13. Next, in step S804, when the model search unit 14 receives a search request of the model information via the model search interface 13, the model search unit 14 determines the search destination. Here, when the version identifier (or date/time) of the process model has been designated, the model search unit 14 searches for the model information corresponding to the version identifier. Meanwhile, if there is no such designation, the model search unit 14 searches the latest version model 3A as the search destination. This is to acquire the model information for deciding the registration information (connection destination) of the association data.

Here, since the latest version model 3A is a reflection of the latest on-site task process and 4M information and on-site data is accumulated in the on-site data accumulation unit 5 based on the current on-site situation, the association data registration unit 12 registers the association data in correspondence with the latest version model 3A unless there is any specific designation. Meanwhile, while there may be cases where the association data is registered after the lapse of a given period of time from the occurrence of the on-site data based on batch processing or the like, in such a case, since the on-site data to be registered could also be the on-site data generated in a past process model accumulated in the model history 3C, and not the latest version model 3A, the configuration also enables the registration of the association data for which the date/time or version of the process model or has been designated.

The association data registration unit 12 may identify the process model corresponding to the model information based on the reply of the model information. In step S807, the association data registration unit 12 creates the association data based on the model information of the identified process model and registers the created association data in the association data accumulation unit 4. The term “registration” referred to herein may illustrate, for example, a case of registering a task node of the task B having a certain task target identifier and connecting it with an output product node to become an output of a task node of the task A having the same task target identifier.

Next, in step S808, the association data registration unit 12 registers the association data in the association data accumulation unit 4. Based on this registration, the association data dependent on the process model of the model information will be registered. Next, in step S809, the association data registration unit 12 sends a reply of the registration result to the data registration device 7.

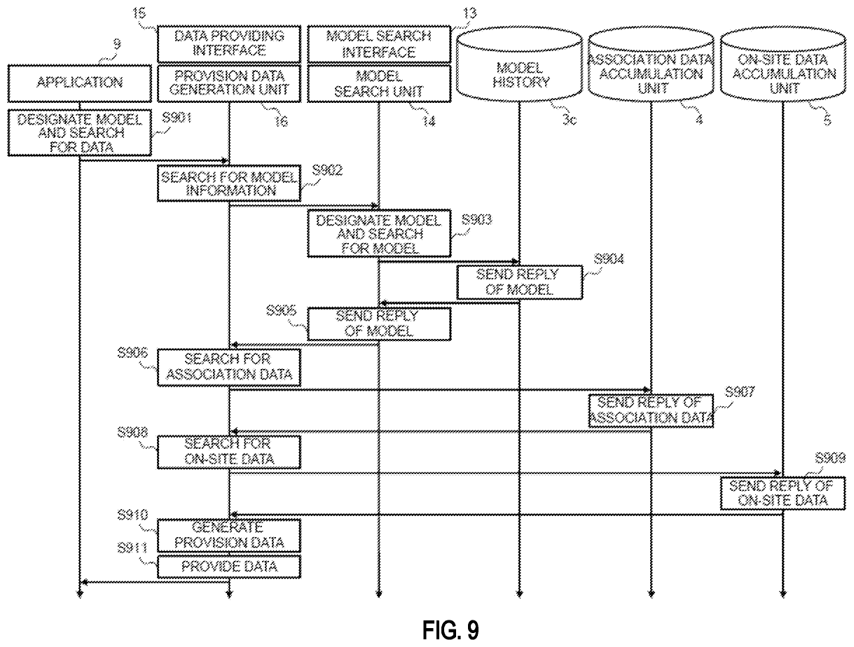

FIG. 9 is a diagram showing an example of the search sequence of the association data and the on-site data.

In step S901, the application 9 makes a search request of the on-site data, in which the process model version has been designated, to the provision data generation unit 16 via the data providing interface 15. The application 9 designates the search conditions of the process model and the search conditions of the on-site data. This, for example, is an image of acquiring the on-site data of the tasks A, C and D based on the November process model with the on-site data of the task A of October and November as the starting point.

In step S902, when the provision data generation unit 16 receives the search request via the data providing interface 15, the provision data generation unit 16 makes a search request of the model information to the model search unit 14 via the model search interface 13 based on the search conditions of the process model.

In step S903, the model search unit 14 searches the model history 3C for the model information in which the date/time or version of process model has been designated. The model search unit 14 checks the existence of data items of the task or 4M to be searched, which are included in the search conditions of the on-site data, and searches for the model information in order to acquire the management information of the on-site data.

In step S904, the model search unit 14 acquires the model information from the model history 3C as a model reply (step S905). The model search unit 14 provides the model information to the provision data generation unit 16 via the model search interface 13.

In step S906, the provision data generation unit 16 searches for related data based on the search conditions of the on-site data. In step S907, the association data accumulation unit 4 sends a reply of the association data that coincides with the search conditions. In step S908, the provision data generation unit 16 makes a search request of the on-site data with the identification information of the on-site data included in the association data as the search key, and receives a reply of the on-site data from the on-site data accumulation unit 5 (step S909). Note that, in the present embodiment, step S903 to step S909 described above do not need to be repeatedly executed in the number of version identifiers of the corresponding process model.

In step S910, the provision data generation unit 16 generates provision data by linking a plurality of on-site data corresponding to the association data based on the reply of the on-site data. In step S911, the provision data generation unit 16 provides the provision data to the application 9 via the data providing interface 15.

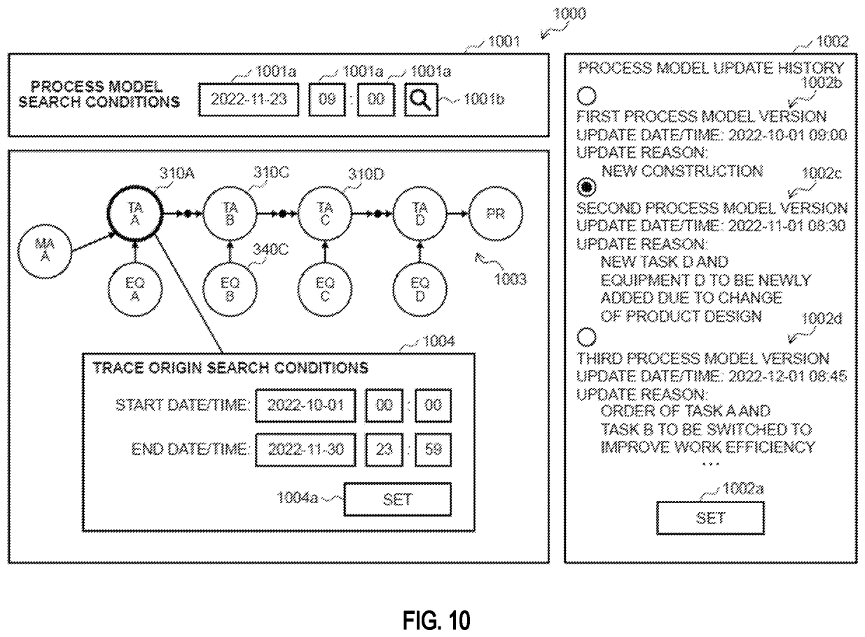

FIG. 10 is a diagram showing an example of a search screen 1000 of the process model and the on-site data. The search screen 1000 of the process model and the on-site data is a screen that is generated by using the model search interface 13 and the data providing interface 15, and includes, as the search conditions of the updated process model, an input column for searching the updated process model by designating the date/time and a selection column for searching the updated process model by designating the version identifier. Specifically, the search screen 1000 of the process model and the on-site data includes a process model search condition column 1001, a process model update history column 1002, a process model display column 1003 and a trace origin search condition column 1004.

The search screen 1000 of the process model and the on-site data acquires, from the model search unit 14, the process model corresponding to the version searched from the process model search condition column 1001 or the process model update history column 1002 via the model search interface 13, and visually displays the process model display column 1003. The search screen 1000 of the process model and the on-site data receives the selection of certain task nodes of the process model displayed on the process model display column 1003, and displays the trace origin search condition column 1004 for inputting the search conditions of the trace origin for tracing the on-site data of a part of the process model for which such selection was received.

The process model search condition column 1001 includes a search condition input column 1001a for inputting the date/time, and a search start button 1001b. When the search start button 1001b is pressed in a state where the date/time has been input to the search condition input column 1001a as the search condition of the process model and the corresponding process model is a hit, the process model is displayed in the process model display column 1003. The task node (shown as “BU A”) and 4M data items (shown as “EQ A” and “MA (material) A”) displayed in the process model display column 1003 are selectable.

The process model update history column 1002 includes radio buttons 1002b to 1002d of the process model candidates and a reflection button 1002a. When the reflection button 1002a is pressed in a state where the process model candidate is selected with one of the radio buttons among the radio buttons 1002b to 1002d of the search process model candidates as the search condition of the process model and the corresponding process model is a hit, the process model is displayed in the process model display column 1003. Similarly, the task nodes and 4M data items displayed in the process model display column 1003 are selectable.

In other words, in order to search for a process model, it is necessary to conduct the search by inputting the search conditions in one column of either the process model search condition column 1001 or the process model update history column 1002. Here, the explanation is provided on the assumption that the search conditions have been set in the process model update history column 1002.

The search conditions of the trace origin for searching the on-site data related to the selected task node or the like (“task A” is selected in the illustrated example) are input in the trace origin search condition column 1004. In the illustrated example, as the search conditions of the trace origin, “Oct. 1, 2022; 00:00” is input as the start date/time, and “Nov. 30, 2022; 23:59” is input as the end date/time. When the setting button 1004a is pressed in a state where the search conditions of the trace origin have been set as described above, the search conditions of the process model are set based on the search conditions set in the process model update history column 1002, and the association data and the search conditions of the on-site data corresponding thereto are set based on the search conditions of the trace origin set in the trace origin search condition column 1004.

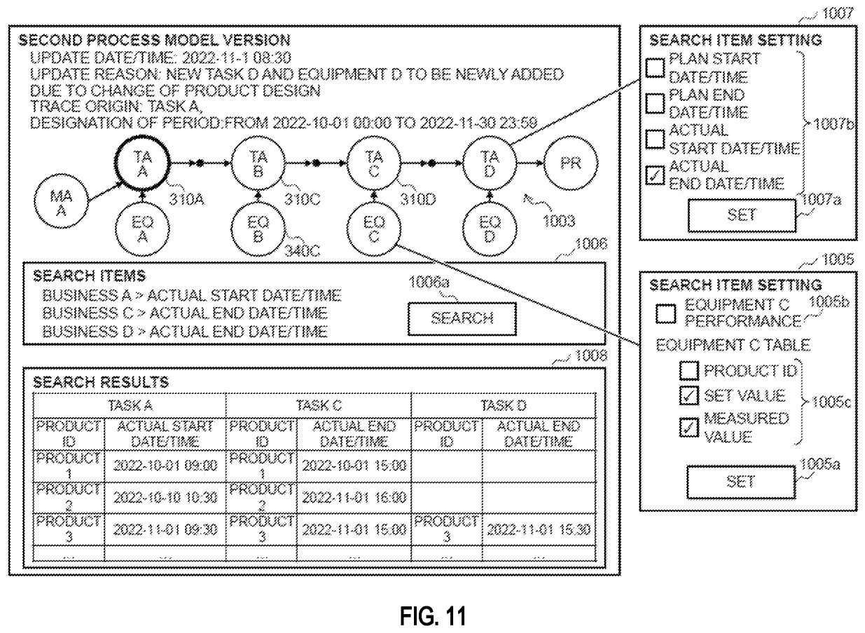

FIG. 11 is a diagram showing an example of the search screen of the process model and the on-site data. When the setting button 1004a of the search conditions of the trace origin is pressed on the search screen 1000 of the process model and the on-site data shown in FIG. 10, the search condition of “second process model” described above and the start date/time of “Oct. 1, 2022; 00:00” and the end date/time of “Nov. 30, 2022; 23:59” as the search conditions of the trace origin are displayed, together with the hit process model, in the process model display column 1003. In the following explanation, the start date/time to the end date/time is referred to as the setting period.

On-site data can also be searched on the illustrated search screen of the process model and the on-site data by selecting the task nodes and 4M data items to be searched. The search items displayed in the search item setting columns 1005 and 1007 are the items defined as the respective task nodes and 4M data items in the second process model. For example, when the task node task D has been selected, the search item setting column 1007 indicated at the upper right corner of FIG. 11 is displayed.

The search item setting column 1007 includes, as search item setting checkboxes 1007b, plan start date/time, plan end date/time, actual start date/time and actual end date/time.

The search item setting column 1007 includes a setting button 1007a and, when the setting button 1007a is pressed, the search item is displayed in the search item column 1006 according to the setting of the foregoing checkbox 1007b.

Moreover, when one of the 4M data items has been selected (“equipment C” in the illustrated example), a checkbox 1005b which enables the selection of, for example, “equipment C performance” as the search item setting column 1005 indicated at the right center of FIG. 11, and a checkbox 1005c which enables the selection of “product ID”, “set value” and “measured value” concerning the equipment C table are displayed. With the search items displayed here, the equipment C performance is defined as the data items of the equipment C in the second process model, and the equipment C performance is stored as the equipment C table in the on-site data accumulation unit, and its column is configured from a product ID, a set value and a measured value. Here, all columns of the equipment C table can also be checked by selecting the checkbox of the equipment C performance. Otherwise, only the required columns may be selectively checked.

The search item setting column 1005 includes a setting button 1005a and, when the setting button 1005a is pressed, search items are displayed in the search item column 1006 according to the setting of the foregoing checkboxes 1005b and 1005c. When the search button 1006a of the search item column 1006 is pressed in a state where the search items are displayed in the search item column 1006, the sequence of FIG. 9 described above is executed. Here, the version identifier (or update date/time) of the second process model is set as the search condition of the process model, and the search of association data from “Oct. 1, 2022; 00:00” to “Nov. 30, 2022; 23:59” as the implementation period of the task A is set as the search condition of the on-site data with the trace origin being the task A. Furthermore, the acquisition of the actual start date/time of the task A, the actual end date/time of the task C, and the actual end date/time of the task D is set as the search condition of the on-site data based on the association data that coincides with the search condition of the trace origin described above. Based on these conditions, the results of executing the sequence of FIG. 9 are displayed in the search result column 1008 indicated at the lower part of FIG. 11. Data corresponding to the search items set as the search items in the search item column 1006 described above are displayed in the search result column 1008 in a state of being linked based on the association data.

In the present embodiment, even when searching for on-site data based on the second process model version, the setting period of the first process model version can be included in the search conditions of the on-site data. Moreover, with the on-site data of the task D that exists in the second process model version but did not exist in the first process model version, the product ID becomes a blank column as shown in the search result column 1008 and a reply of “no on-site data” is sent as a result of the search related to product 1 and product 2.

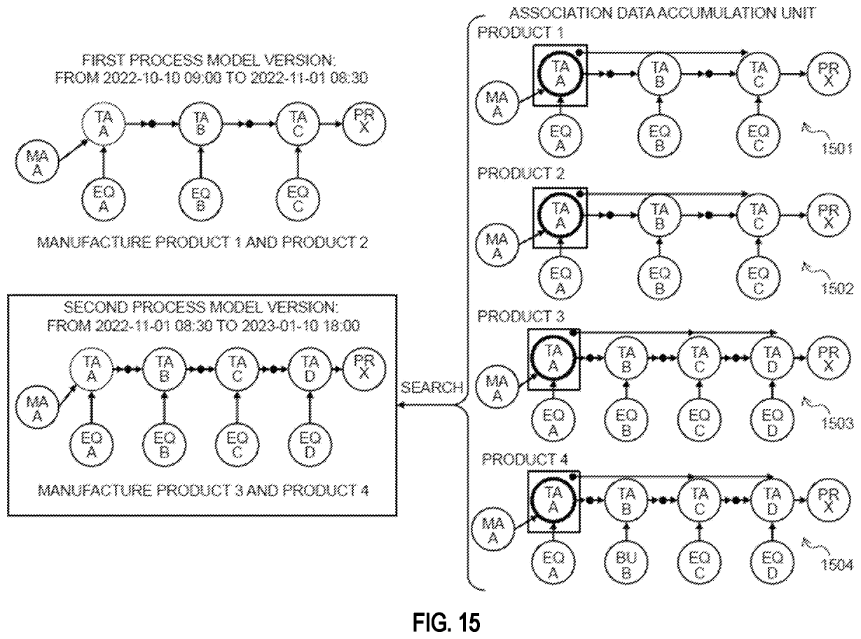

FIG. 15 is an image diagram of searching for the association data based on the search conditions shown in FIG. 11. For example, when products having a product ID of product 1 and product 2 are manufactured in the first process model, association data 1501, 1502 corresponding to product 1 and product 2 are accumulated in the association data accumulation unit based on the first process model. Similarly, for example, when products having a product ID of product 3 and product 4 are manufactured in the second process model, the association data 1503, 1504 corresponding to product 3 and product 4 are accumulated in the association data accumulation unit based on the second process model. When searching for association data with the trace origin being the task A and the implementation period of the task A being “Oct. 1, 2022; 00:00” to “Nov. 30, 2022; 23:59”, association data of the task A corresponding to product 1, product 2, product 3 and product 4 will coincide with the conditions. The acquisition of the actual start date/time of the task A, the actual end date/time of the task C, and the actual end date/time of the task D which were set as the search items are acquired by following the connection of the association data that coincides with the conditions.

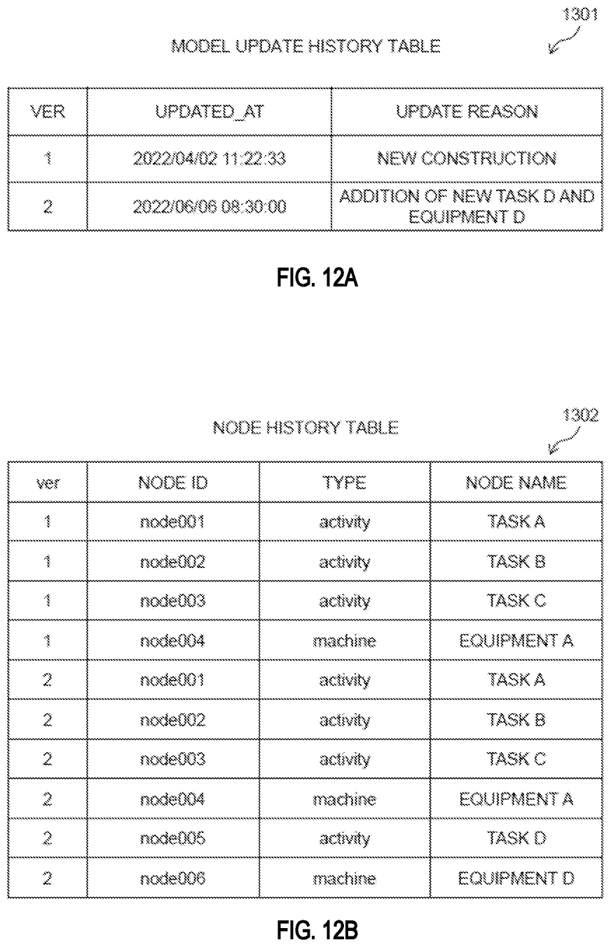

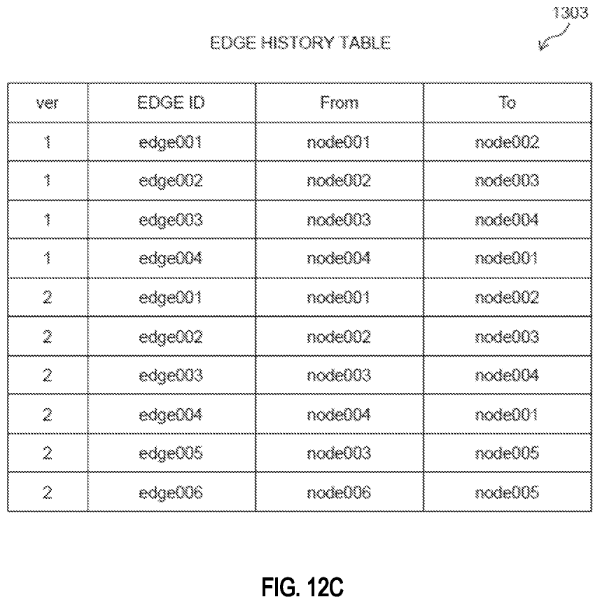

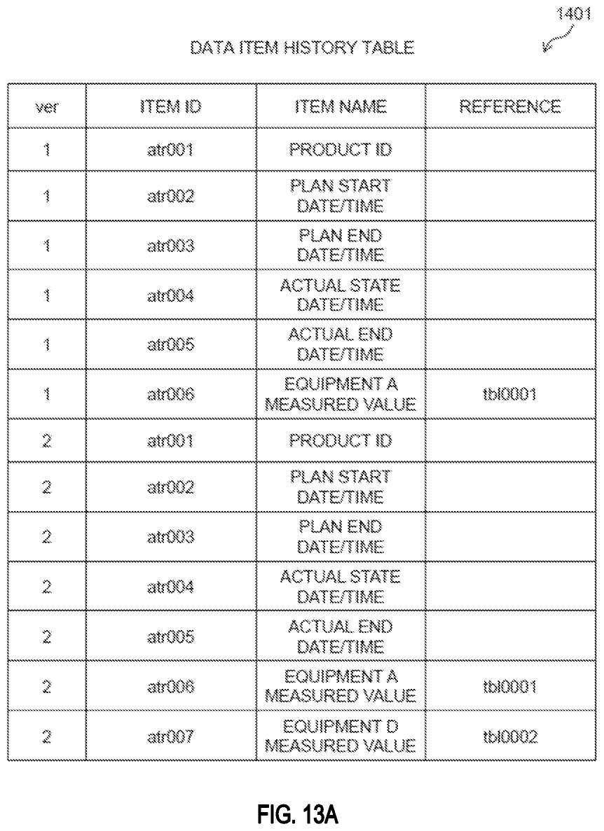

FIG. 12A to FIG. 12C are diagrams showing an example of model history table configuring the model history 3C. FIG. 12A shows a model update history table 1301, FIG. 12B shows a node history table 1302, and FIG. 12C shows an edge history table 1303. Note that the illustrated “ver” corresponds to the version identifier of the process model.

The model update history table 1301 shown in FIG. 12A is managing the update date/time (corresponds “update_at” shown in the diagram) and the update reason of the process model for each version identifier of the process model. The update reason of “new construction” shows that a process model was newly created. Moreover, the update reason of “addition of new task D and equipment D” shows that the task D and the equipment D were newly added to an existing process model.

The node history table 1302 shown in FIG. 12B is managing the node, ID, type and node name for each version identifier of the process model. The node ID is an identifier for mutually identifying the task nodes and 4M data items. With the type, “activity” shows a task node, and “machine” shows an equipment node. Otherwise, types that show the 4M nodes such as “material”, “man” and “method” may also exist. The node name shows the name of the node corresponding to the node ID.

The edge history table 1303 shown in FIG. 12C is managing the edge ID, input source (shown as “From”) and output destination (shown as “To”) for each version identifier of the process model.

The edge ID is an identifier for mutually identifying the edges between a plurality of task nodes or the edges of the task nodes and the 4M nodes. The input source shows the node ID of the task node or the 4M node as the starting point of the digraph. The output destination shows the node ID of the task node or the 4M node as the ending point of the digraph.

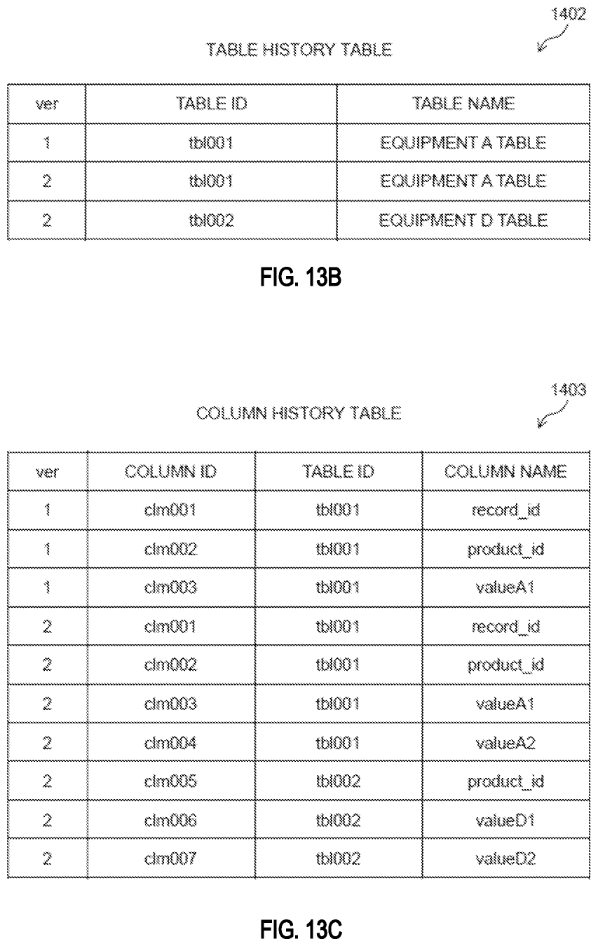

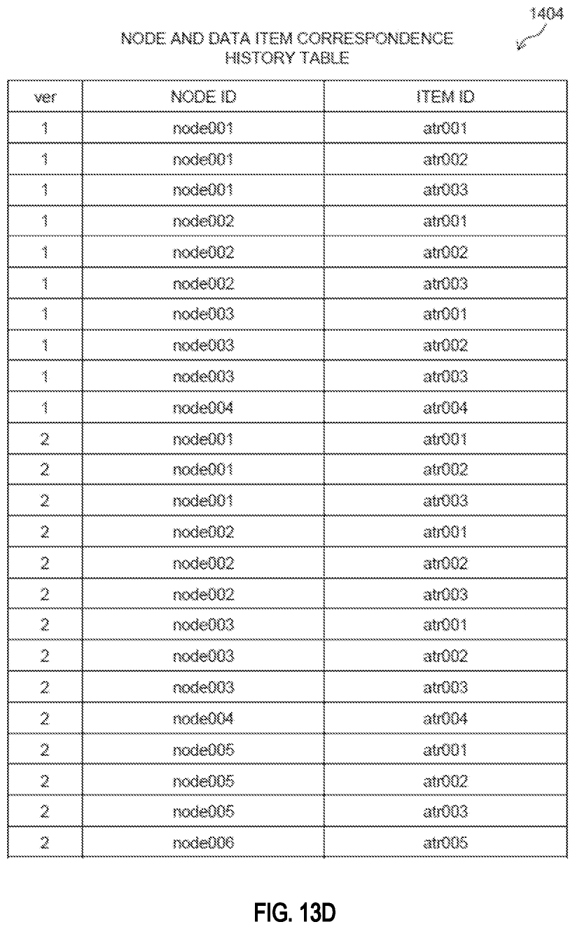

FIG. 13A to FIG. 13D are each a diagram showing an example of the model history table. FIG. 13A shows a data item history table 1401, FIG. 13B shows a table history table 1402, FIG. 13C shows a column history table 1403, and FIG. 13D shows a node and data item correspondence history table 1404. Note that the illustrated “ver” corresponds to the version identifier of the process model as with the example shown above.

The data item history table 1401 shown in FIG. 13A is managing the item ID, item name and reference for each version identifier of the process model. The item ID is an identifier capable of mutually identifying a plurality of data items. The item name indicates the name of the data item. The reference indicates the table ID of the table name of the reference described later.

The table history table 1402 shown in FIG. 13B is managing the table ID and the table name for each version identifier of the process model. The table ID indicates the identifier assigned to each table. The table name indicates the name of each table.

The column history table 1403 shown in FIG. 13C is managing the column ID, table ID, and column name for each version identifier of the process model. The column ID is an identifier for mutually identifying the columns of each table. The table ID indicates the table having the column corresponding to the column ID. The column name indicates the name of the column corresponding to the column ID.

The node and data item correspondence history table 1404 shown in FIG. 13D is managing the node ID and item ID for each version identifier of the process model. The node ID is an identifier capable of mutually identifying a plurality of task nodes or 4M nodes. The item ID is an identifier capable of mutually identifying a plurality of data items. The node and data item correspondence history table 1404 is managing the relationship with the data items of FIG. 13A of the respective task nodes or 4M nodes of the node history table shown in FIG. 12B.

The data collection display system 100 according to the present embodiment comprises an on-site data accumulation unit 5 which accumulates on-site data, a association data accumulation unit 4 which accumulates a plurality of association data, which is data for managing relevance between tasks and which associates a task node corresponding to the task and the on-site data related to the task, a model history 3C as an example of a version management unit which manages a version identifier of a plurality of process models by associating it with model information of the plurality of process models, a model creation unit 11 as an example of a version identifier update unit which, each time any process model among the plurality of process models is updated, updates the version identifier managed by the model history 3C by associating it with the model information of the updated process model, a association data registration unit 12 which registers association data based on a process model corresponding to a specific version identifier among the plurality of process models, a model search unit 14 which searches the model history 3C with the date/time or version identifier corresponding to the updated process model as a search key, and searches for model information that coincides with the search key among the plurality of process models, and a provision data generation unit 16 which identifies the task and the on-site data related to the task from the relevant data related to the process model corresponding to the model information, and externally provides the identified data.

The data collection display method of a data collection display system according to the present embodiment comprises an on-site data accumulation step of accumulating the on-site data in an on-site data accumulation unit 5, a association data accumulation step of accumulating a plurality of association data, which is data for managing relevance between tasks and which associates a task node corresponding to the task and the on-site data related to the task, in a association data accumulation unit 4, a version management step of using a model history 3C and managing a version identifier of a plurality of process models by associating it with model information of the plurality of process models, a version identifier update step of a model creation unit 11 as an example of a version identifier update unit, each time any process model among the plurality of process models is updated, updating the version identifier managed by the model history 3C by associating it with the model information of the updated process model, a association data registration step of registering association data based on a process model corresponding to a specific version identifier among the plurality of process models, a model information search step of a model search unit 14 searching the model history 3C with the date/time or version identifier corresponding to the updated process model as a search key, and searching for model information that coincides with the search key among the plurality of process models, and a provision data generation step of a provision data generation unit 16 identifying the task and on-site data related to the task from the relevant data related to the process model corresponding to the model information, and externally providing the identified on-site data.

For example, if a product is defective, it is necessary to comprehend, based on on-site data, what kind of task process was used to manufacture the defective product and how each of the tasks configuring that task process was conducted, and thereby investigate the cause of defect. Here, the cause of defect cannot necessarily be identified by only analyzing the on-site data of the defective product, and it is necessary to perform the analysis while comparing it with the on-site data related to products that were manufactured before and after the defective product. Nevertheless, the process model at the time of manufacture of the defective product and the process model at the time of manufacture of products before and after the defective product are not necessarily the same. The data collection display system 100 according to the present embodiment separates the search conditions of the process model and the search conditions of the on-site data, and can reduce the time required for identifying the on-site data even when a product becomes defective under circumstances where the process model is updated sequentially.

The data collection display system 100 according to the present embodiment comprises a model data accumulation unit 3 including a model under edit 3B that manages a process model in which its update has been started and which is being updated among the plurality of process models, a latest version model 3A that manages a latest version process model of the model under edit 3B in which its update has been completed, and a model history 3C. By adopting the foregoing configuration, the update status of the update target process model can be accurately managed using the model history 3C.

In the present embodiment, when the model creation unit 11 starts the update of the update target process model among a plurality of process models, it causes the update target process model to be the model under edit 3B. Subsequently, when the model creation unit 11 completes the update of the update target process model, it causes the update target process model (that is, process model of the model under edit 3B) to be the latest version model 3A. By adopting the foregoing configuration, the update status of the update target process model by the model creation unit 11 can be accurately managed using the model history 3C.

In the present embodiment, the model history 3C as an example of the version management unit manages the version identifier of the process model and the update date/time of the process model corresponding to the version identifier, and the model search unit 14 displays a search screen of the process model and the on-site data at least including a process model search condition column 1001 as an example of the input column of searching for the updated process model based on the designation of the date/time as the search conditions of the updated process model. By adopting the foregoing configuration, the process model that was valid as of such date/time can be identified without having to designate the version identifier of the process model, and on-site data can be searched using the identified process model.

In the present embodiment, the model search unit 14 displays, as a part of a screen of the process model and the on-site data, a process model display column 1003 that visually shows the process model corresponding to the version identifier or the date/time input in the process model search condition column 1001, accepts a selection of certain task nodes of the process model shown in the process model display column 1003, and displays a trace origin search condition column 1004 in which a search condition of a trace origin for tracking the on-site data concerning a part of the process model for which the selection has been accepted can be input. By adopting the foregoing configuration, on-site data that is identified based on the model information of the updated process model can be comprehended without having to designate the date/time or the version identifier as the search condition of the updated process model.

### (2) Modified Example of the Present Embodiment

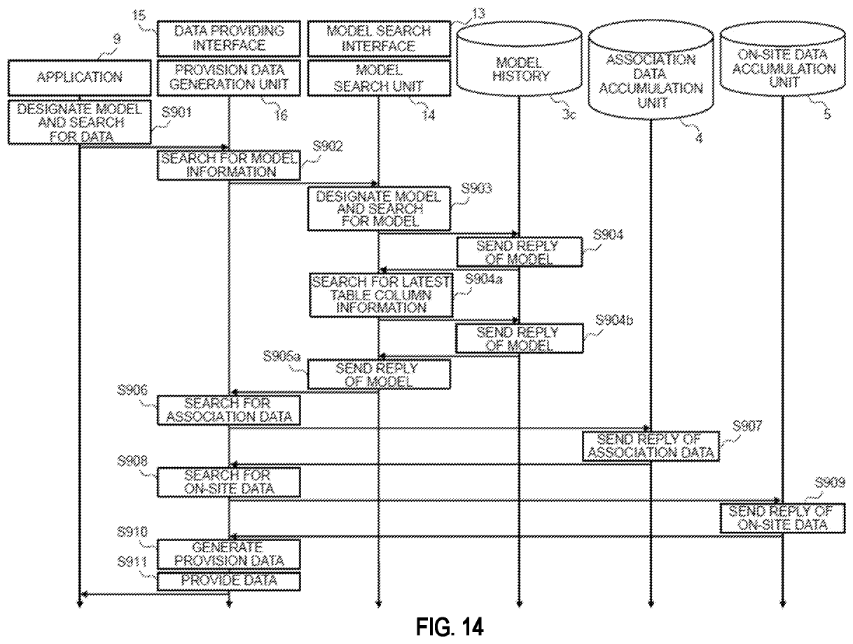

FIG. 14 is a diagram showing an example of the search sequence of the association data and the on-site data according to a modified example of the present embodiment. Since the search sequence of the association data and the on-site data shown in FIG. 14 is basically the same as the search sequence of the association data and the on-site data shown in FIG. 9, the differences will be mainly explained below.

The management information 370 of the on-site data among the constituent elements of the process model shown in FIG. 3 manages the configuration information of the on-site data stored in the on-site data accumulation unit 5. The process model is also updated when there is any change to the management information 370 of the on-site data. Here, since the on-site data including the configuration information before the change will not exist after the change, when an attempt is made to acquire on-site data from the current on-site data accumulation unit 5 based on the management information of the on-site data of the past process model searched based on the search conditions of the process model, it may result in an acquisition error.

For example, let it be assumed that the columns of the equipment C table are “product ID”, “set value”, and “measured value”. Here, let it be assumed that the columns of the equipment C table have been changed to “product ID”, “set value”, “measured value 1”, and “measured value 2” as a result of the measured value acquired from the equipment C having been added. In the foregoing case, when an attempt is made to acquire the on-site data of the “measured value” column from the equipment C table based on the process model before the change, since the “measured value” column does not exist in the current equipment C table, it will result in a data acquisition error.

In the modified example of the present embodiment, the model history 3C is managing the on-site data management information of the on-site data accumulation unit 5 as the model information of the process model. The model search unit 14 acquires information in the latest version process model for the management information of on-site data among the constituent elements of the process model, and acquires the on-site data based on the management information of on-site data in the latest version process model. Otherwise, it can also be said that the model search unit 14 acquires the latest version process model based on the latest version model, changes the on-site data management information to the on-site data management information of the latest version process model of the model information of the acquired process model as a result of the search based on the version identifier of the process model or the search date/time, and acquires the on-site data based on the on-site data management information of the latest version process model. This is now explained in detail.

The search sequence of the association data and the on-site data shown in FIG. 14 differs with respect to the point that steps S904a and S904b have been added to the search sequence of the association data and the on-site data shown in FIG. 9.

In the modified example of the present embodiment, even in a case of searching for on-site data based on the process model of an old version from the past, on-site data is searched using information of the latest process model for the management information of on-site data such as tables and columns related to the on-site data.

Specifically, with the search sequence of the association data and the on-site data shown in FIG. 14, similar to the case of FIG. 9, in step S904, the model search unit 14 acquires information of the corresponding process model from the model history 3C based on the search conditions of the process model. Subsequently, in step S904a, the model search unit 14 searches for the management information of on-site data such as tables and columns corresponding to the latest version process model from the model history 3C. In step S904b, the management information of the latest on-site data is sent as a model reply. Consequently, in step S905a, the model search unit 14 sends the management information of the latest on-site data to the provision data generation unit 16 as a model reply via the model search interface 13. The provision data generation unit 16 uses the thus acquired management information of the latest on-site data and searches for the on-site data in step S908. Since subsequent step S906 to step S911 are the same as step S906 to step S911 shown in FIG. 9, the explanation thereof is omitted.

### (3) Other Modified Examples

Note that, while three types of data generation devices 6; namely, a worker data generation device 6a, an equipment/machine data generation device 6b, and a part/product data generation device 6c, were illustrated in the present embodiment, the present invention is not limited thereto, and other data generation devices may be illustrated.

In the present embodiment, while the mode shown in FIG. 3 was illustrated as an example of the process model 300, the present invention is not limited thereto, the process model 300 may also be another mode.

### INDUSTRIAL APPLICABILITY

The present invention can be applied to a data collection display system that collects on-site data from on-site data generation devices arranged in the factory's production equipment.

### REFERENCE SIGNS LIST

1 . . . information system, 2 . . . network, 3 . . . data model accumulation unit, 4 . . . association data accumulation unit, 5 . . . on-site data accumulation unit, 6 . . . data generation device, 6A . . . data generation device, 6B . . . data generation device, 6C . . . data generation device.

1. A data collection display system, comprising:
an on-site data accumulation unit which accumulates on-site data;
a association data accumulation unit which accumulates a plurality of association data, which is data for managing relevance between tasks and which associates a task node corresponding to the task and the on-site data related to the task;
a version management unit which manages a version identifier of a plurality of process models by associating it with model information of the plurality of process models;
a version identifier update unit which, each time any process model among the plurality of process models is updated, updates the version identifier managed by the version management unit by associating it with the model information of the updated process model;
a association data registration unit which registers association data based on a process model corresponding to a specific version identifier among the plurality of process models;
a model information search unit which searches the version management unit with the date/time or version identifier corresponding to the updated process model as a search key, and searches for model information that coincides with the search key among the plurality of process models; and
a provision data generation unit which identifies the task and the on-site data related to the task from the relevant data related to the process model corresponding to the model information, and externally provides the identified data.

2. The data collection display system according to claim 1, further comprising a model data accumulation unit including:
a model under edit that manages a process model in which its update has been started and which is being updated among the plurality of process models;
a latest version model that manages a latest version process model of the model under edit in which its update has been completed; and
a model history as the version management unit.

3. The data collection display system according to claim 1, wherein:
the version management unit manages a version identifier of the process model, and an update date/time of the process model corresponding to the version identifier; and
the model information search unit displays a screen including an input column for inputting, as a search condition of the updated process model, at least a search date/time or the version identifier corresponding to the updated process model.

4. The data collection display system according to claim 3, wherein:
the model information search unit displays, as a part of the screen, a process model display column that visually shows the process model corresponding to the version identifier or the search date/time input in the input column, accepts a selection of certain task nodes of the process model shown in the process model display column, and displays a trace origin search condition column in which a search condition of a trace origin for tracking the on-site data concerning a part of the process model for which the selection has been accepted can be input.

5. The data collection display system according to claim 2, wherein:
the version management unit manages on-site data management information of the on-site data accumulation unit as model information of the process model; and
the model information search unit:
acquires a latest version process model based on the latest version model;
changes the on-site data management information to on-site data management information of the latest version process model among the model information of the acquired process model as a result of the search conducted based on the search date/time or the version identifier of the process model; and
acquires on-site data based on the on-site data management information of the latest version process model.

6. A data collection display method of a data collection display system which collects on-site data, the method comprising:
an on-site data accumulation step of accumulating the on-site data in an on-site data accumulation unit;
a association data accumulation step of accumulating a plurality of association data, which is data for managing relevance between tasks and which associates a task node corresponding to the task and the on-site data related to the task, in a association data accumulation unit;
a version management step of using a version management unit and managing a version identifier of a plurality of process models by associating it with model information of the plurality of process models;
a version identifier update step of a version identifier update unit, each time any process model among the plurality of process models is updated, updating the version identifier managed by the version management unit by associating it with the model information of the updated process model;
a association data registration step of registering association data based on model information of a process model corresponding to a specific version identifier among the plurality of process models;
a model information search step of a model search unit searching the version management unit with the date/time or version identifier corresponding to the updated process model as a search key, and searching for model information that coincides with the search key among the plurality of process models; and
a provision data generation step of a provision data generation unit identifying the task and on-site data related to the task from the relevant data related to the process model corresponding to the model information, and externally providing the identified on-site data.
